(19) United States
(12) Patent Application Publication
(10) Pub. No.: US 2009/0296253 A1
(43) Pub. Date: Dec. 3, 2009

(54) CONTROL APPARATUS, STORAGE DEVICE, AND SYSTEM-INFORMATION STORAGE METHOD

(75) Inventors: Yuji Karakawa, Kawasaki (JP); Hidekazu Masuyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/359,082

(22) Filed: Jan. 23, 2009

(30) Foreign Application Priority Data
May 28, 2008 (JP) 2008-140042

(51) Int. Cl. G11B 27/036; G11B 21/02

(52) U.S. Cl. 360/31; 360/75; G9B/27.052; G9B/21.003

(57) ABSTRACT

A magnetic disk device performs test write to check the state of each of heads before system information is stored in a disk and, based on the result of the test write, stores the system information sequentially with the heads from one in good state. After a predetermined time has elapsed, the magnetic disk device suspends the process of storing the system information.

### CROSS-REFERENCE TO RELATED APPLICATIONS

This application is based upon and claims the benefit of priority of the prior Japanese Patent Application No. 2008-140042, filed on May 28, 2008, the entire contents of which are incorporated herein by reference.

### BACKGROUND

1. Field

The embodiments discussed herein are related to a control apparatus, a storage device, and a system-information storage method of storing system information in a storage medium by using a head.

2. Description of the Related Art

In general, a storage device stores system information in a specific area. Examples of the system information include control data for controlling the operation of the device (e.g., defect data and mode parameters) and log data indicative of previous operations (e.g., statistical information about the number of reads/writes and error details). Reference may be had to Japanese Laid-open Patent Publication No. 2006-48789. Although stored at various timings, for example, the system information is stored when an event, such as an error or receipt of Reset, occurs as is the case of log data.

For example, when an A command is issued from a host, a magnetic disk device analyzes the A command. As a result of analysis, when an error is detected in the A command, the magnetic disk device notifies the host of the error, then writes the content of the error to a medium as system information, and stores data (see FIG. 6).

At the time of storing the system information, when in a state where a write error is likely to occur (e.g., when the magnetic disk is vibrating), the magnetic disk device retries writing attempts, and thus takes more time than in a normal state.

Besides, the system information is data that influences the operation of the device and is therefore important. Accordingly, for increasing reliability, the magnetic disk device stores the same data in a multiple manner in several locations (e.g., all heads). This multiple storage can cause a time delay.

As described above, in the conventional technology, when in a state where a write error is likely to occur (e.g., when the magnetic disk is vibrating) upon storing the system information, the magnetic disk device retries writing attempts, and thus takes more time than in a normal state.

As a result, even when the host issues a command, the magnetic disk device may not execute the command, and the host detects a timeout (see FIG. 7). That is, a timeout occurs due to a cause unknown to a host side.

### SUMMARY

It is an object of the present invention to at least partially solve the problems in the conventional technology.

According to an aspect of an embodiment, a control apparatus includes: a head test unit that performs, before system information is stored in a storage medium of a storage device, a test to check state of heads of the storage device; a system-information storing unit that stores the system information sequentially with the heads from a head in good state based on a result of the test by the head test unit; and a storage suspending unit that suspends storage of the system information performed by the system-information storing unit after a predetermined time has elapsed.

According to another aspect of an embodiment, a storage device includes: a head test unit that performs, before system information is stored in a storage medium, a test to check state of heads; a system-information storing unit that stores the system information sequentially with the heads from a head in good state based on a result of the test by the head test unit; and a storage suspending unit that suspends storage of the system information performed by the system-information storing unit after a predetermined time has elapsed.

According to still another aspect of an embodiment, a system-information storage method includes: performing, before system information is stored in a storage medium of a storage device, a test to check state of heads of the storage device; storing the system information sequentially with the heads from a head in good state based on a result of the test; and suspending storage of the system information after a predetermined time has elapsed.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram of a magnetic disk device according to an embodiment;

FIG. 2 is a diagram of an example of a test write-result table;

FIG. 3 is a schematic diagram for explaining test write process;

FIG. 4 is a flowchart of a system-information storage process performed by the magnetic disk device according to the embodiment;

FIG. 5 is a schematic diagram for explaining test write process; and

FIGS. 6 and 7 are schematic diagrams for explaining a conventional technology.

### DETAILED DESCRIPTION OF THE PREFERRED EMBODIMENTS

Exemplary embodiments of the present invention are described in detail below with reference to the accompanying drawings.

Described below is the configuration of a magnetic disk device according to an embodiment and the operation thereof. Although a magnetic disk device is described below as an example of a storage device, the present invention can be applied to other storage devices than the magnetic disk device, such as a magneto-optical disk.

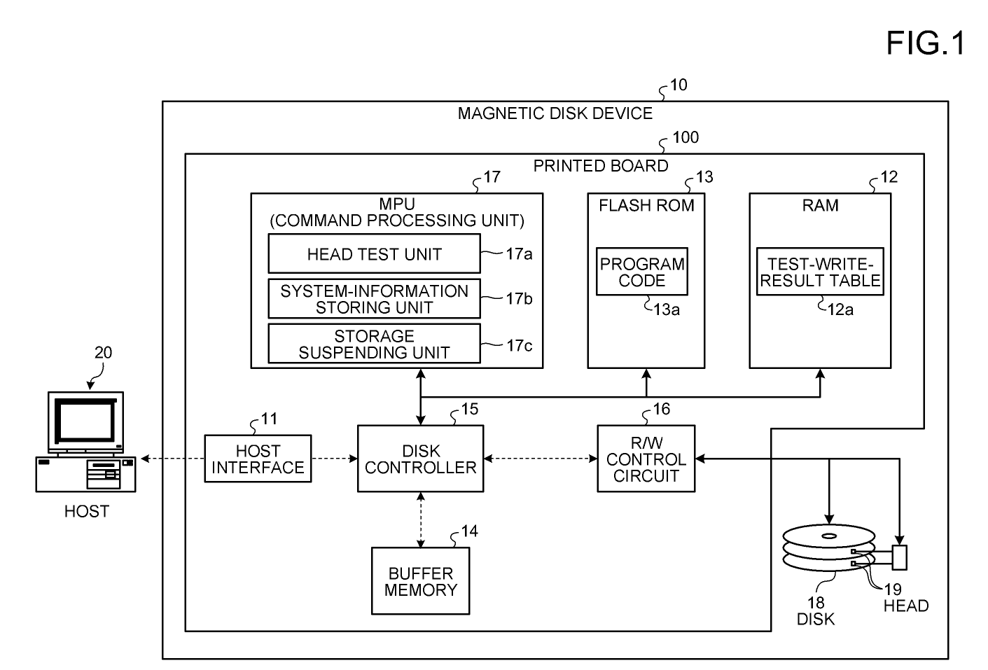

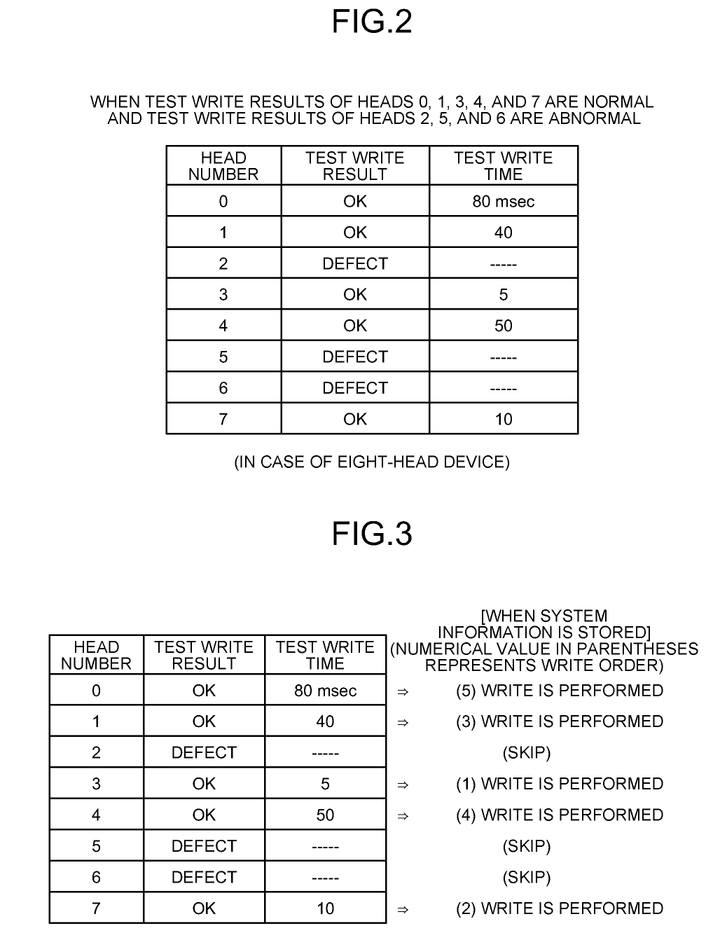

With reference to FIGS. 1 to 3, the configuration of a magnetic disk device 10 according to an embodiment is explained. FIG. 1 is a block diagram of the magnetic disk device 10. FIG. 2 is a diagram of an example of a test write-result table. FIG. 3 is a schematic diagram for explaining test write process.

As depicted in FIG. 1, the magnetic disk device 10 includes a printed board 100, disks 18, and heads 19, and is connected to a host 20. The operation of each of these components is explained below.

The disks 18 are a plurality of magnetic disks for recording various data and position control information. In the disks 18, a predetermined area is set as a test cylinder. On the test cylinder, a head test unit 17a, which will be described later, performs test write, thereby checking each header.

Each of the heads 19 has incorporated therein an electrical-magnetic converting element formed of a read element and a write element, and performs reading and writing various data and position control information from and to the disks 18.

The printed board 100 includes a host interface 11, a Random Access Memory (RAM) 12, a Flash Read Only Memory (ROM) 13, a buffer memory 14, a disk controller 15, a Read/Write (R/W) control circuit 16, and a Micro processing Unit (MPU) (command processing unit) 17.

The host interface 11 controls communication regarding various information exchanged with the connected host 20. Specifically, the host interface 11 receives an obtained command from the host 20, and transmits the process result and an error report to the host 20.

The RAM 12 stores a test write-result table 12a. The test-write-result table 12a stores the results of a test performed by the head test unit 17a, which will be described later. Specifically, as exemplified in FIG. 2, the test-write-result table 12a stores “head number” that uniquely identifies each head, “test write result” representing results of test write, and “test write time” taken for test write of each head in association with each other.

The Flash ROM 13 stores data and programs needed for various processes by the MPU 17 and, in particular, stores program codes 13a. The program codes 13a form a program needed for various processes, and are read by the MPU 17, which will be described later. The buffer memory 14 is a cache that temporarily stores data to be read or written between the host 20 and the disks 18.

The disk controller 15 notifies the R/W control circuit 16 of a read/write control signal based on a command reported from the host 20. The disk controller 15 stores recording information read from the disks 18 in the buffer memory 14, and then transmits the information to the host 20 via the host interface 11. The R/W control circuit 16 performs a read/write process on the disks 18 based on the read/write control signal reported from the disk controller 15.

The MPU (command processing unit) 17 includes an internal memory for storing programs defining various process procedures and necessary data, and performs various processes based on these programs and data. The MPU 17 includes the head test unit 17a, a system-information storing unit 17b, and a storage suspending unit 17c.

The head test unit 17a checks the state of each of the heads 19 before the system information is stored. Specifically, when an event that starts or triggers a system-information storage process (e.g., an error or receipt of Reset) occurs, before the system information is stored, the head test unit 17a performs test write on the test cylinder to check the state of each head. The head test unit 17a then stores the test results in the test-write-result table 12a of the RAM 12.

Since it should not take time to perform such test write, a timer monitors the time to prevent a timeout. Also provided is a function of suspending the test write after a predetermined time. Besides, in a test sense, conditions for the number of retries is restrictively set to be smaller than normal settings.

The system-information storing unit 17b stores the system information sequentially from a head in a good state based on the test write results stored in the test-write-result table 12a. Specifically, based on the test write results stored in the test-write-result table 12a, the system-information storing unit 17b uses a head with the shortest test write time to store the system information.

The system-information storing unit 17b then determines whether the system information is stored with all normal heads. As a result, when determining that the system information is not stored with all normal heads, the system-information storing unit 17b uses, among heads with which the system information is not stored, the one with the shortest test write time to store the system information.

Then, while storing the system information, the system-information storing unit 17b repeatedly stores the system information until it receives an instruction from the storage suspending unit 17c, which will be described later, for suspending storage or stores the system information with all normal heads.

Test write process is explained by using an example of FIG. 3. As depicted in FIG. 3, the system-information storing unit 17b first uses a head with head number “3”, which is with the shortest test write time, to store the system information. The system-information storing unit 17b then uses heads with head numbers “7” “1” “4”, and “0” to sequentially perform storage process until a predetermined time elapses and an instruction for suspending storage process is received. As for heads with head numbers “2”, “5”, and “6”, the system-information storing unit 17b skips storage process.

That is, the system information is stored sequentially from heads with shorter test write time. With this, multiple writes can be made as many as possible within a predetermined time period, which increases the possibility that the system information is updated to the latest.

The storage suspending unit 17c suspends storing of the system information after the predetermined time has elapsed. Specifically, if the predetermined time has elapsed after the start of the process of storing the system information, the storage suspending unit 17c notifies the system-information storing unit 17b of suspension of the storage process, and suspends storing of the system information.

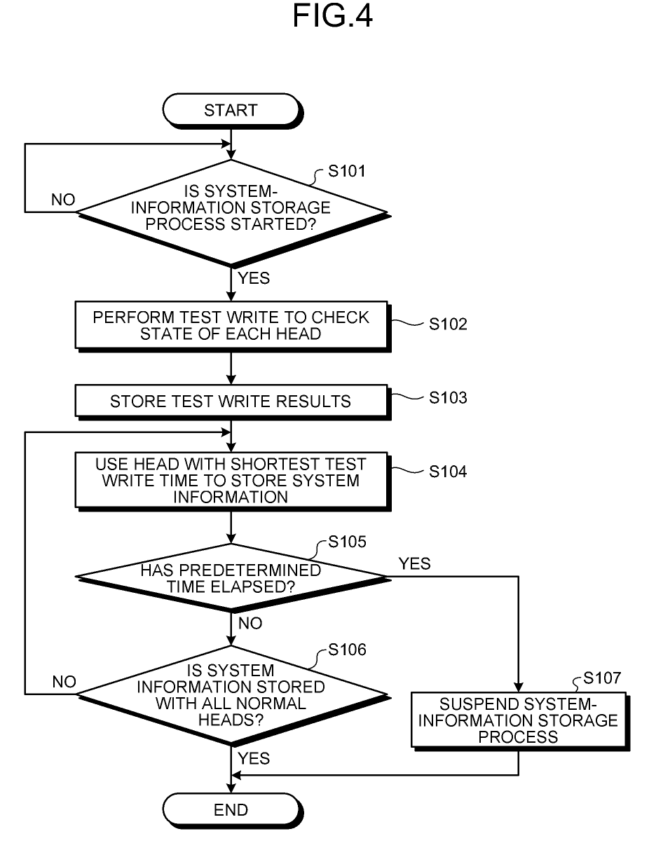

Next, with reference to FIG. 4, the operation of the magnetic disk device 10 according to the embodiment is explained. FIG. 4 is a flowchart of the operation of the magnetic disk device 10.

As depicted in FIG. 4, when an event starting a system-information storage process (e.g., an error or receipt of Reset) occurs (Step S101), before storing the system information, the magnetic disk device 10 performs test write to check the state of each head (Step S102). The magnetic disk device 10 then stores the test result in the test-write-result table 12a of the RAM 12 (Step S103).

Then, based on test write results stored in the test-write-result table 12a, the magnetic disk device 10 uses a head with the shortest test write time to store the system information (Step S104).

The magnetic disk device 10 then determines whether a predetermined time has elapsed (Step S105). If the predetermined time has elapsed (Yes at Step S105), the system-information storage process is suspended (Step S107).

On the other hand, if the predetermined time has not elapsed (No at Step S105), the magnetic disk device 10 determines whether the system information is stored with all normal heads (Step S106). If it is not stored with all normal heads (No at Step S106), the process returns to Step S104.

The magnetic disk device 10 then uses one of the heads with which the system information is not stored, the one with the shortest test write time to store the system information. The magnetic disk device 10 then repeatedly stores the system information until the predetermined time has elapsed or the system information is stored with all normal heads (Steps S104 to S106).

As described above, according to the embodiment, the magnetic disk device 10 checks the state of the heads 19 before the system information is stored in the disks 18 and, based on the state of the heads 19, stores the system information sequentially from the head 19 in a good state. Then, after the predetermined time has elapsed, the magnetic disk device 10 suspends the system-information storage process. With this, it is possible to prevent the occurrence of a timeout due to a cause unknown to a host side as well as store the system information in a multiple manner as much as possible within a predetermined time.

Moreover, the magnetic disk device 10 stores the system information sequentially from a head with a short test write time as a head in a good state. With this, the magnetic disk device 10 can achieve multiple writes as much as possible within a predetermined time and increase the possibility that the system information is updated to the latest.

Furthermore, based on the result of testing the state of each head, the system-information storage process is skipped for a defective head. With this, the system information is stored by using only heads without a problem, which prevents a write error.

While an embodiment of the present invention has been described and illustrated, the present invention is not limited to the embodiment but is capable of numerous rearrangements, modifications and substitutions of parts and elements.

For example, in the above embodiment, test write is described as being performed when an event that starts or triggers a system-information storage process (e.g., an error or receipt of Reset) occurs. Alternatively, test write may be performed at predetermined time intervals or regularly to check the state of each head. Specifically, the magnetic disk device may perform test write for each head between command processes in a patrol manner.

In this case, whether the state of each head is abnormal is checked at predetermined time intervals, i.e., test write is performed for each head between command processes. As a result, overhead due to a test information write can be suppressed to the minimum.

In the above embodiment, the system information is described by way of example as being stored sequentially from a head with a shorter test write time. Alternatively, the system information may be stored sequentially from a head with a lower error rate.

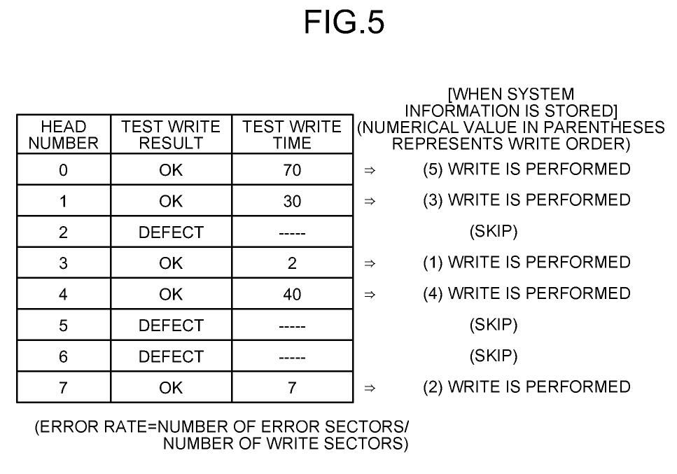

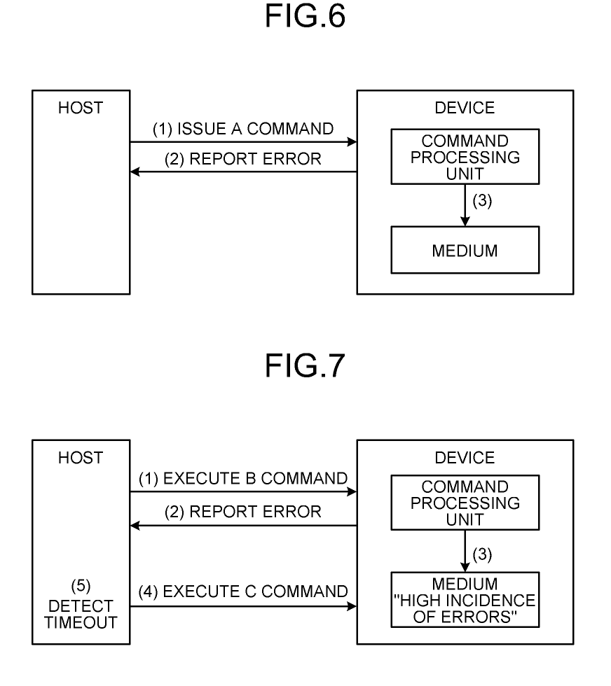

A specific explanation is given with reference to FIG. 5. As depicted in FIG. 5, the magnetic disk device first uses a head with head number “3” with the lowest error rate to store the system information. The magnetic disk device then uses heads with head numbers “7” “1”, “4”, and “0” for sequential storing until a predetermined time has elapsed and an instruction for suspending storing is received. On the other hand, the system-information storing unit 17b skips storing with heads with head numbers “2”, “5”, and “6”.

In this manner, if the system information is stored sequentially from a head with a low error rate as a head in a good state, multiple writes can be performed as much as possible within a predetermined time, which increases the possibility that the system information is updated to the latest.

The constituent elements of the magnetic disk device described above are functionally conceptual, and need not be physically configured as illustrated. In other words, the specific mode of dispersion and integration of the constituent elements is not limited to the ones illustrated in the drawings, and the constituent elements, as a whole or in part, can be divided or integrated either functionally or physically based on various types of loads or use conditions. All or any part of the processing functions performed by the device or the units can be realized by a Memory Control Unit (MCU) or a control apparatus such as a Central Processing Unit (CPU) or a Micro Processing Unit (MPU) and a program analyzed and executed by the MCU or the control apparatus, or can be realized as hardware by wired logic.

As set forth hereinabove, according to an embodiment of the present invention, it is possible to prevent the occurrence of a timeout due to a cause unknown to a host side as well as to store system information in a multiple manner.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A control apparatus comprising:
a head test unit that performs, before system information is stored in a storage medium of a storage device, a test to check state of heads of the storage device;
a system-information storing unit that stores the system information sequentially with the heads from a head in good state based on a result of the test by the head test unit; and
a storage suspending unit that suspends storage of the system information performed by the system-information storing unit after a predetermined time has elapsed.

2. The control apparatus according to claim 1, wherein the head in good state is a head with shortest test write time.

3. The control apparatus according to claim 1, wherein the head in good state is a head with lowest error rate.

4. The control apparatus according to claim 1, wherein the system-information storing unit skips storage of the system information with a defective head based on the result of the test.

5. A storage device comprising:
a head test unit that performs, before system information is stored in a storage medium, a test to check state of heads;
a system-information storing unit that stores the system information sequentially with the heads from a head in good state based on a result of the test by the head test unit; and
a storage suspending unit that suspends storage of the system information performed by the system-information storing unit after a predetermined time has elapsed.

6. A system-information storage method comprising:
performing, before system information is stored in a storage medium of a storage device, a test to check state of heads of the storage device;
storing the system information sequentially with the heads from a head in good state based on a result of the test; and
suspending storage of the system information after a predetermined time has elapsed.
